(19) United States
(12) Patent Application Publication
(10) Pub. No.: US 2009/0093268 A1
(43) Pub. Date: Apr. 9, 2009

(54) COMMUNICATION EQUIPMENT

(75) Inventor: Shigeru Amano, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: Oki Semiconductor Co., Ltd., Tokyo (JP)

(21) Appl. No.: 12/235,864

(22) Filed: Sep. 23, 2008

(30) Foreign Application Priority Data
Oct. 5, 2007 (JP) 2007262091

(51) Int. Cl. H04M 1/00

(52) U.S. Cl. 455/550.1

(57) ABSTRACT

A communication equipment which is capable of avoiding receipt errors caused by a broadcasting receiver while a communication device is conducting communication. An adaptable current control unit stops adaptable current control of the broadcasting receives while the communication device is performing a transmission process.

The present application claims priority under 35 U.S.C. 119 to Japanese patent application serial number 2007/262091, filed on Oct. 5, 2007, which is hereby incorporated by reference in its entirety for all purposes.

### BACKGROUND OF THE INVENTION

### Field of the Invention

The present invention relates to communication equipment including a broadcasting receiver for receiving terrestrial digital broadcasting in a portable communication device such as a portable telephone for example.

A type of communication equipment recently developed and of interest incorporates in a mobile unit a broadcasting receiver for receiving broadcasting waves for mobile reception of a terrestrial digital broadcasting including audio/video and data such as “one-seg” or one-segment broadcasting, and a portable telephone equipped with a communication device for communicating with different portable telephones. The broadcasting receiver generally includes a tuner in which current is controlled to be limited when a receipt level of the broadcasting wave is high, in order to reduce power consumption of the communication equipment.

In addition, in the prior art it is conventional that if there occurs interference in a second radio unit due to a transmission wave from a first radio unit, complex radio terminals are capable of preventing such interference by changing an operating current of transmission power of the first radio unit such that a level of harmonics of the transmission wave is lowered, thereby allowing transmission/receipt operation by a plurality of radio units (for example, see Japanese Patent Application Publication No. 2001-267955).

However, when the above-mentioned communication equipment incorporating the broadcasting receiver and the communication device communicates with different communication equipment by use of the communication devices, a high level of signal may be output from power amplifiers and the like within the communication devices. This may cause an electric wave emerging from the communication devices to act as an interference wave in the broadcasting receiver. As a result, a broadcasting wave may be received with error due to saturation of an amplifier within a tuner of the broadcasting receiver.

Accordingly, there arises a need in the above-mentioned communication equipment for operation to avoid broadcasting receiver error while a communication device is conducting communication. However, the complex radio terminal disclosed in Japanese Patent Application Publication No. 2001-267955 as noted above is not described as operating to cause one radio unit to avoid a receipt error when another radio unit performs a transmission/receipt operation.

### SUMMARY OF THE INVENTION

In order to overcome the above problems, it is an object of the present invention to provide communication equipment including a broadcasting receiver and a communication device as a unit which is capable of avoiding receipt error by the broadcasting receiver while the communication device is conducting communication.

According to one aspect of the present invention, for attaining the above object there is provided a communication equipment including a communication device that conducts communication of information; and a broadcasting receiver including a receiving unit that receives a broadcasting wave while current is being supplied thereto, and a current control unit that controls a supply amount of the current depending on receipt conditions of the broadcasting wave when the communication device is communicating, and that stops the control of the supply amount of the current when the communication device is communicating.

With this configuration, since control of the supply amount of current responsive to the receipt condition of the broadcasting wave is stopped, it is possible to avoid broadcasting receiver receipt errors while the communication device is conducting communication.

According to a second aspect of the present invention, there is provided a communication equipment including a communication device including a communication unit that conducts communication of information while a first current is being supplied thereto, and a control unit that controls a supply amount of the first current depending on conditions of the communication; and a broadcasting receiver including a receiving unit that receives a broadcasting wave while a second current is being supplied thereto, and a current control unit that controls an amount of the second current supplied to the receiving unit depending on receipt conditions of the broadcasting wave when the communication device is not communicating, and that controls the amount of the second current supplied to the receiving unit depending on the supply amount of the first current controlled by the control unit while the communication is communicating.

With this configuration, since the amount of current supplied to the receiving unit of the broadcasting receiver is controlled by the control unit while the communication device is conducting communication, it is possible to save energy as well as avoid broadcasting receiver receipt errors.

Accordingly, the communication equipment of the present invention has as an advantage that receipt errors caused by a broadcasting receiver can be avoided while a communication device is conducting communication.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a schematic view showing a configuration of a portable telephone according to a first embodiment of the present invention; and

FIG. 2 is a schematic view showing a configuration of a portable telephone according to a second embodiment of the present invention.

### DETAILED DESCRIPTION OF THE PREFERRED EMBODIMENTS

Hereinafter, preferred embodiments of the present invention will be described with reference to the accompanying drawings.

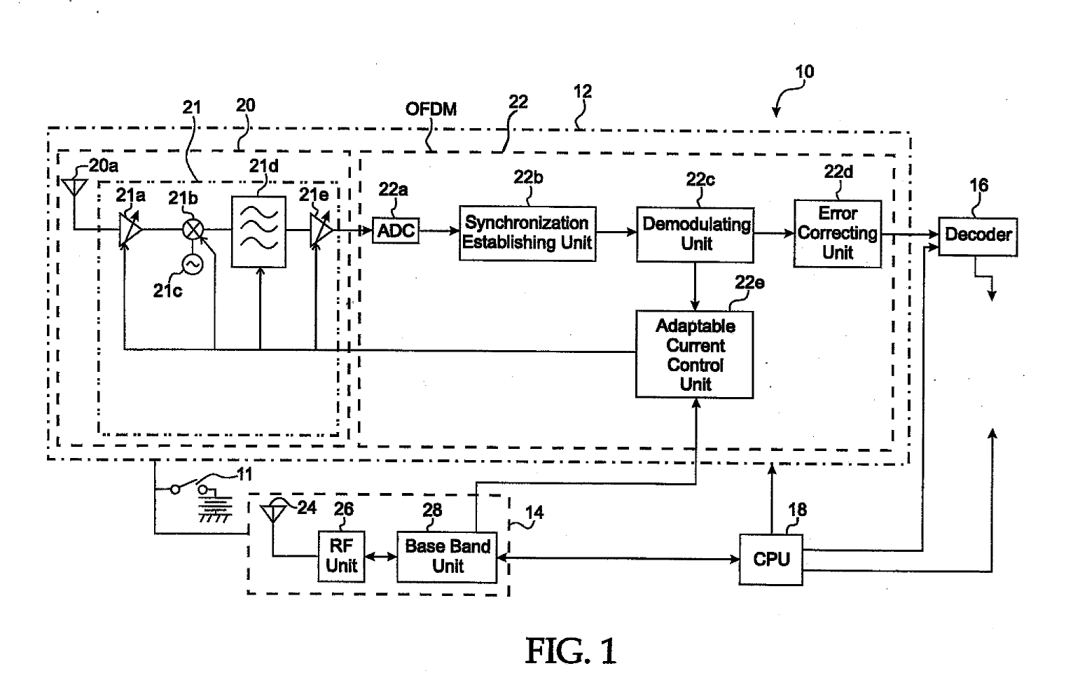

In a first embodiment of the present invention, an example of a portable telephone employed as communication equipment will be described. As shown in FIG. 1, a portable telephone 10 of this embodiment includes a broadcasting receiver 12, a communication device 14, a decoder 16 and a CPU 18. A switch 11 is connected to the broadcasting receiver 12 and the communication device 14. When the switch 11 is in an ON state, current is supplied to the broadcasting receiver 12 and the communication device 14.

The broadcasting receiver 12 shown in FIG. 1 includes a receiving unit 20 and an OFDM (Orthogonal Frequency Division Multiplexing) demodulator 22.

The receiving unit 20 shown in FIG. 1 includes an antenna 20a for receiving a broadcasting wave (high frequency) such as one-segment (one-seg) broadcasting and a tuner 21. The tuner 21 includes an RFVGA (Radio Frequency Variable Gain Amplifier) 21a, a frequency converter (mixer) 21b, a local oscillator 21c, a band pass filter 21d and an IFVGA (Intermediate Frequency Variable Gain Amplifier) 21e. During operation of the tuner 21, the RFVGA 21a amplifies a high frequency signal received by the antenna 20a, the frequency converter 21b obtains an intermediate frequency signal by mixing the amplified high frequency signal with a local signal from the local oscillator 21c, the band pass filter 21d extracts a low band intermediate frequency signal from the obtained intermediate frequency signal, and finally the IFVGA 21e amplifies and outputs a final intermediate frequency signal.

The OFMD demodulator 22 shown in FIG. 1 includes an ADC (analog to digital converter) 22a, a synchronization establishing unit 22b, a demodulating unit 22c, an error correcting unit 22d and an adaptable current control unit 22e. The ADC 22a converts the analog intermediate frequency signal that is output from the IFVGA 21e within the tuner 21 into a digital signal. The synchronization establishing unit 22b outputs a synchronization reproduction signal by performing synchronization establishment on the digitally converted intermediate frequency signal output from the ADC 22a. The demodulating unit 22c outputs a demodulated signal and a S/N ratio of the demodulated signal by performing fast Fourier transformation on the synchronization reproduction signal output from the synchronization establishing unit 22b. The error correcting unit 22d corrects an error in the demodulated signal output from the demodulating unit 22c, performs a de-interleaving process on the corrected demodulated signal, and outputs a TS (Transport Stream) signal. These above noted circuit elements and manner of functioning should be well within the level of ordinary skill, and further description thereof is omitted.

The adaptable current control unit 22e shown in FIG. 1 determines a receipt level of a broadcasting wave (UHF) based on the S/N ratio of the demodulated signal provided by the demodulating unit 22c, when a transmission control signal output from base band unit 28 is inactive, as will be described in greater detail later. Responsive to an increase of the receipt level of the broadcasting wave based on the provided S/N ratio, the adaptable current control unit 22e controls an operating current of the tuner 21 such that the amount of supply of operating current to the RFVGA 21a, the frequency converter 21b, the band pass filter 21d and the IFVGA 21e of the tuner 21 is decreased. In contrast, responsive to decrease of the receipt level of the broadcasting wave (UHF) based on the provided S/N ratio, the adaptable current control unit 22e controls an operating current of the tuner 21 such that the amount of supply of operating current to the RFVGA 21a, the frequency converter 21b, the band pass filter 21d and the IFVGA 21e of the tuner 21 is increased.

That is, operating current of the tuner 21 is controlled as described above, when the transmission control signal from base band unit 28 is inactive and thus indicative that the communication device 14 is not transmitting. With such control, control by the adaptable current control unit 22e is stopped when the transmission control signal from the base band unit 28 is active and thus indicative that the communication device 14 is transmitting. Hereinafter, the control of current supply amount by the adaptable current control unit 22e is referred to as adaptable current control.

The decoder 16 shown in FIG. 1 separates the TS signal which is provided from the error correcting unit 22d and which is multiplexed with various kinds of information, into the various kinds of information, and then outputs the resultant information to a speaker, an earphone and a display device (which are not shown).

The communication device 14 as shown in FIG. 1 includes an antenna 24 for receiving a radio wave, an RF (Radio Frequency) unit 26 and the base band unit 28.

The RF unit 26 as shown in FIG. 1 has a transmission/receipt circuit for transmission/receipt of sound signals and data in a predetermined frequency band. The RF unit 26 performs communication processes including a process of amplifying and frequency-converting an RF signal of a radio wave received via the antenna 24 and outputting the resultant frequency converted signal to the base band unit 28 (a so-called receipt process), and a process of frequency-converting and amplifying a signal input from the base band unit 28 and outputting the resultant signal as a radio wave via the antenna 24 (a so-called transmission process). In addition, the RF unit 26 measures an RSSI (Receiver Signal Strength Indicator) of the RF signal of the radio wave received via the antenna 24 and outputs the measured value to the base band unit 28.

The base band unit 28 shown in FIG. 1 demodulates the frequency converted signal provided from the RF unit 26, and outputs the demodulated signal to the CPU 18. In addition, the base band unit 28 modulates a sound signal and data provided from the CPU 18 and outputs the modulated sound signal and data to the RF unit 26. The base band unit 28 also controls the amount of current supplied to the RF unit 26 in multiple steps based on a RSSI value input from the RF unit 26. Furthermore, the base band unit 28 sets the transmission control signal to the adaptable current control unit 22e to be active when the RF unit 26 performs a transmission process, and sets the transmission control signal to the adaptable current control unit 22e to be inactive when the RF unit 26 does not perform a transmission process.

The CPU 18 controls the broadcasting receiver 12, the communication device 14 and the decoder 16.

Next, an operation of the portable telephone 10 will be described. In the following description, an example of receiving a one-seg broadcasting while the portable telephone 10 is sending an electronic mail will be described. However, it should be understood that the broadcasting should not necessarily be limited specifically to one-seg broadcasting, and that other terrestrial digital broadcastings may be used. It should also be understood that communication device 14 should not be limited to sending electronic mail, and that voice may also be sent. Moreover, the communication equipment should not necessarily be limited to mobile units, since the following may be equally applicable to other types of communication systems.

Responsive to an instruction to transmit electronic mail and an instruction to receive one-seg broadcasting from an operation panel (not shown) that received corresponding user instructions while executing an electronic mail edition program stored in a ROM (not shown), the CPU 18 instructs the broadcasting receiver 12 to receive the one-seg broadcasting and instructs the base band unit 28 to send electronic mail transmission data and electronic mail stored in a RAM (not shown). At this time, the instructed base band unit 28 modulates a signal with the electronic mail transmission data and the RF unit 26 frequency-converts and amplifies the signal modulated by the base band unit 28 and outputs the resultant signal as a radio wave via the antenna 24. Thus, the transmission of electronic mail is completed. In addition, the base band unit 28 sets the transmission control signal to the adaptable current control unit 22e to be active while the RF unit 26 is sending the electronic mail.

Meanwhile, the instructed broadcasting receiver 12 initiates receipt of the one-seg broadcasting and outputs a corresponding TS signal to the decoder 16. The decoder 16 separates the TS signal into various kinds of information to be output to a speaker, an earphone and a display device. Thus, sound is output from the speaker or the earphone, and an image is displayed on the display device.

Since the transmission control signal from the base band unit 28 is active, the adaptable current control unit 22e stops the control of the supply amount of the operating current to the tuner 21. Thus, without the reduction of the supply amount of current to the amplifiers (RFVGA 21a and IFVGA 21e) of the tuner 21, it is possible to avoid broadcasting wave receipt errors due to saturation of the amplifiers. In other words, it is possible to avoid a receipt error due to the adaptable current control performed by the adaptable current control unit 22e.

As described above, according to this embodiment, since the adaptable current control unit 22e stops the adaptable current control while the communication device 14 is conducting a transmission process, it is possible to avoid a receipt error which may occur due to the adaptable current control.

Although it has been described in this embodiment that the adaptable current control unit 22e stops the adaptable current control while the communication device 14 is conducting a transmission process, it should be understood that the adaptable current control unit 22e may perform to stop the adaptable current control while the communication device 14 is conducting a receipt process. In such a case, since the adaptable current control unit 22e stops the adaptable current control while the communication device 14 is conducting the receipt process, it is possible to avoid a receipt error which may occur due to the adaptable current control. In a further alternative, the adaptable current control unit 22e may perform to stop adaptable current control while the communication device 14 is in transmission process and while the communication device 14 is in a receipt process.

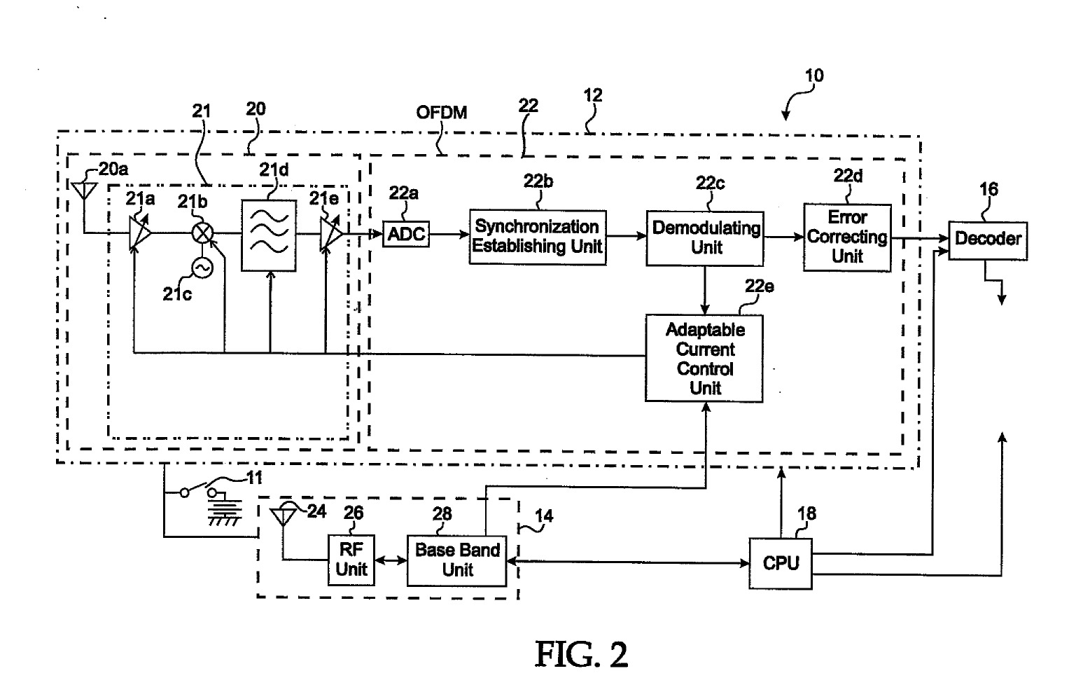

A second embodiment of the invention will now be described with reference to FIG. 2. In the second embodiment, the same circuit elements, configuration and processes as in the first embodiment are designated with like reference numerals and are similar, and explanation thereof will be omitted for the sake of brevity.

In the portable telephone 10 of the second embodiment, similar to the first embodiment as described with respect to FIG. 1, the base band unit 28 controls the amount of current supplied to the RF unit 26 in multiple steps based on a RSSI value input from the RF unit 26. Thus, transmission power may be assumed to be weak while the RF unit 26 is conducting a transmission process. At this time, with the adaptable current control by the adaptable current control unit 22e, it may happen that the amplifiers within the tuner 21 may not enter into saturation even with reduction of the supply amount of current to the amplifiers and so on of the tuner 21. In such a case, no receipt errors occur in the broadcasting receiver 12.

Thus, in this second embodiment as described with respect to FIG. 2, the minimal supply amount of current that would result in no receipt errors in the broadcasting receiver 12 is experimentally determined in advance for each step of the amount of current supplied to the RF unit 26 by the base band unit 28. In addition, a table that stores a determined minimal supply amount of current for each of the corresponding amounts of current supplied to the RF unit 26 is included in the adaptable current control unit 22e. As shown in FIG. 2, while communication is being conducted, the base band unit 28 sends a signal to the adaptable current control unit 22e indicative of the amount of current supplied to the RF unit 26, and the adaptable current control unit 22e accesses the stored table to acquire the minimal supply amount of current that would result in no receipt error for the corresponding amount of current supplied to the RF unit 26. Adaptable current control unit 22e accordingly performs the adaptable current control for the tuner 21 such that the amount of current supplied to the tuner 21 is not less than the determined minimal supplied amount of current. Thus, the adaptable current control can be performed with more precision, thereby saving energy as well as avoiding broadcasting receiver receipt errors.

What is claimed is:

1. A communication equipment comprising:
a communication device that conducts communication of information; and
a broadcasting receiver including
a receiving unit that receives a broadcasting wave while current is being supplied thereto, and
a current control unit that controls a supply amount of the current depending on receipt conditions of the broadcasting wave when the communication device is communicating, and that stops the control of the supply amount of the current when the communication device is communicating.

2. The communication equipment of claim 1, wherein the communication device is a telephone that communicates email transmissions.

3. The communication equipment of claim 1, wherein the communication device is a telephone that communicates voice transmissions.

4. The communication equipment of claim 1, wherein the broadcasting wave is a terrestrial digital broadcast.

5. The communication equipment of claim 1, wherein the broadcasting wave is a one-segment broadcast.

6. The communication equipment of claim 1, wherein the current control unit stops the control of the supply amount of current when the communication device is in a transmitting mode.

7. The communication equipment of claim 1, wherein the current control unit stops the control of the supply amount of current when the communication device is in a receive mode.

8. The communication equipment of claim 1, which is a mobile unit.

9. The communication equipment of claim 1, wherein the receiving unit includes a variable gain amplifier that amplifies the received broadcasting wave, the current control unit providing the supply amount of the current to the variable gain amplifier.

10. A communication equipment comprising:
a communication device including
a communication unit that conducts communication of information while a first current is being supplied thereto, and
a control unit that controls a supply amount of the first current depending on conditions of the communication; and
a broadcasting receiver including
a receiving unit that receives a broadcasting wave while a second current is being supplied thereto, and
a current control unit that controls an amount of the second current supplied to the receiving unit depending on receipt conditions of the broadcasting wave when the communication device is not communicating, and that controls the amount of the second current supplied to the receiving unit depending on the supply amount of the first current controlled by the control unit while the communication is communicating.

11. The communication equipment of claim 10, wherein the communication device is a telephone that communicates email transmissions.

12. The communication equipment of claim 10, wherein the communication device is a telephone that communicates voice transmissions.

13. The communication equipment of claim 10, wherein the broadcasting wave is a terrestrial digital broadcast.

14. The communication equipment of claim 10, wherein the broadcasting wave is a one-segment broadcast.

15. The communication equipment of claim 10, which is a mobile unit.

16. The communication equipment of claim 10, wherein the receiving unit includes a variable gain amplifier that amplifies the received broadcasting wave, the current control unit providing the supply amount of the current to the variable gain amplifier.

17. The communication equipment of claim 10, wherein the current control unit includes a table that stores a corresponding amount of the second current to be supplied to the receiving unit for each corresponding supply amount of the first current provided by the control unit to the communication unit.
